(19) United States
(12) Patent Application Publication
(10) Pub. No.: US 2026/0213514 A1
(43) Pub. Date: Jul. 23, 2026

(54) CABLE HANGER MOUNTS AND RELATED ASSEMBLIES

(71) Applicant: Outdoor Wireless Networks LLC, Richardson, TX (US)

(72) Inventors: Marcus J. Ash, Castle Rock, CO (US); Serge Honeysett, Clay, NY (US)

(21) Appl. No.: 19/422,625

(22) Filed: Dec. 17, 2025

Related U.S. Application Data
(60) Provisional application No. 63/747,167, filed on Jan. 20, 2025.

(51) Int. Cl. H02G 7/05; H01B 17/24; H01B 17/32; H02G 7/20

(52) U.S. Cl. CPC H02G 7/053; H01B 17/24; H01B 17/32; H02G 7/20

(57) ABSTRACT

The present disclosure is directed to a cable hanger mount. The cable hanger mount includes a base section including a slot, the base section configured to engage a mounting structure and be secured to the mounting structure via a banding mechanism received through the slot. The cable hanger mount further includes a body section coupled to or integrally formed with the base section and extending outwardly and generally perpendicularly therefrom. The body section includes a plurality of apertures, each aperture configured to receive a respective cable hanger or hardware to secure the cable hanger or hardware to the mount.

### RELATED APPLICATION(S)

This application claims priority to and the benefit of U.S. Provisional Patent Application Ser. No. 63/747,167, filed on Jan. 20, 2025, the disclosures of which are incorporated herein by reference in full.

### FIELD

The present invention generally relates to telecommunications equipment and, more particularly, mounts for cable hangers and related cable hanger mount assemblies.

### BACKGROUND

With the rise in the number of antenna ports provided in base station antennas, the available space at the top of an antenna tower is becoming increasingly limited, making it challenging to securely support corresponding cable assemblies. Thus, there may be a need for alternative devices to help optimize cable management in these constrained spaces.

### SUMMARY

Embodiments of the present invention are directed to a cable hanger mount. The cable hanger mount includes a base section including a slot, the base section configured to engage a mounting structure and be secured to the mounting structure via a banding mechanism received through the slot. The cable hanger mount further includes a body section coupled to or integrally formed with the base section and extending outwardly and generally perpendicularly therefrom. The body section includes a plurality of apertures, each aperture configured to receive a respective cable hanger or hardware to secure the cable hanger or hardware to the mount.

Further embodiments of the present invention are directed to a cable hanger mount. The cable hanger mount includes a base section and a body section. The base section includes a slot and is configured to engage a mounting structure and be secured to the mounting structure via a banding mechanism received through the slot. The body section is coupled to or integrally formed with the base section and extending outwardly and generally perpendicularly therefrom. The body section includes a plurality of apertures, each aperture configured to receive a respective cable hanger or hardware to secure the cable hanger or hardware to the mount. The cable hanger mount further includes one or more engagement features extending outwardly from the base section opposite to the body section, the one or more engagement feature being configured to provide additional contact surface area for the cable hanger mount to engage with different types of mounting structures. The cable hanger mount further includes a removable angle adapter configured to be secured to the base section. The angle adapter has a main body that defines a recess configured to receive an end of an angled mounting structure to secure the cable hanger mount thereto.

Further embodiments of the present invention are directed to a cable hanger mount. The cable hanger mount includes a body section having a generally elongated rectangular shape and includes a front wall, a rear wall, and opposing side walls. The front wall includes a plurality of apertures, each aperture configured to receive a respective cable hanger to secure the cable hanger to the mount. The rear wall includes at least one banding slot and the opposing side walls include a plurality of open slots. The slots in the rear wall and the opposing side walls are configured to receive a banding mechanism, thereby allowing the cable hanger mount to be secured to a mounting structure in different orientations relative to the mounting structure.

It is noted that aspects of the invention described with respect to one embodiment, may be incorporated in a different embodiment although not specifically described relative thereto. That is, all embodiments and/or features of any embodiment can be combined in any way and/or combination. Applicant reserves the right to change any originally filed claim and/or file any new claim, accordingly, including the right to be able to amend any originally filed claim to depend from and/or incorporate any feature of any other claim or claims although not originally claimed in that manner. These and other objects and/or aspects of the present invention are explained in detail in the specification set forth below. Further features, advantages and details of the present invention will be appreciated by those of ordinary skill in the art from a reading of the figures and the detailed description of the preferred embodiments that follow, such description being merely illustrative of the present invention.

### BRIEF DESCRIPTION OF THE DRAWINGS

FIG. 1A is a top view of a cable hanger mount according to embodiments of the present invention.

FIG. 1B is a side view of the cable hanger mount shown in FIG. 1A.

FIG. 1C is a bottom view of the cable hanger mount shown in FIG. 1A.

FIG. 2A is a side view of an example mounting assembly in which the cable hanger mount of FIGS. 1A-1C is secured to a rectangular mounting structure according to embodiments of the present invention.

FIG. 2B is a partial top view of an example mounting assembly in which the cable hanger mount of FIGS. 1A-1C is secured to a cylindrical or round mounting structure according to embodiments of the present invention.

FIG. 2C is a partial top view of an example mounting assembly in which the cable hanger mount of FIGS. 1A-1C is secured to an angled mounting structure according to embodiments of the present invention.

FIG. 3A is a front view of a cable hanger mount according to embodiments of the present invention.

FIG. 3B is a side view of the cable hanger mount shown in FIG. 3A.

FIG. 3C is a rear view of the cable hanger mount shown in FIG. 3A.

FIG. 4A is a side view of an example mounting assembly in which the cable hanger mount of FIGS. 3A-3C is secured to a rectangular mounting structure according to embodiments of the present invention.

FIG. 4B is a front view of the mounting assembly shown in FIG. 4A.

FIG. 5A is a top view of a cable hanger mount assembly according to embodiments of the present invention.

FIG. 5B is a side view of the cable hanger mount assembly shown in FIG. 5A.

### DETAILED DESCRIPTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

The present invention now will be described more fully hereinafter with reference to the accompanying drawings, in which illustrative embodiments of the invention are shown. Like numbers refer to like elements throughout and different embodiments of like elements can be designated using a different number of superscript indicator apostrophes (e.g., 10′, 10″, 10′″).

In the figures, certain layers, components or features may be exaggerated for clarity, and broken lines illustrate optional features or operations unless specified otherwise. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention. The sequence of operations (or steps) is not limited to the order presented in the claims or figures unless specifically indicated otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

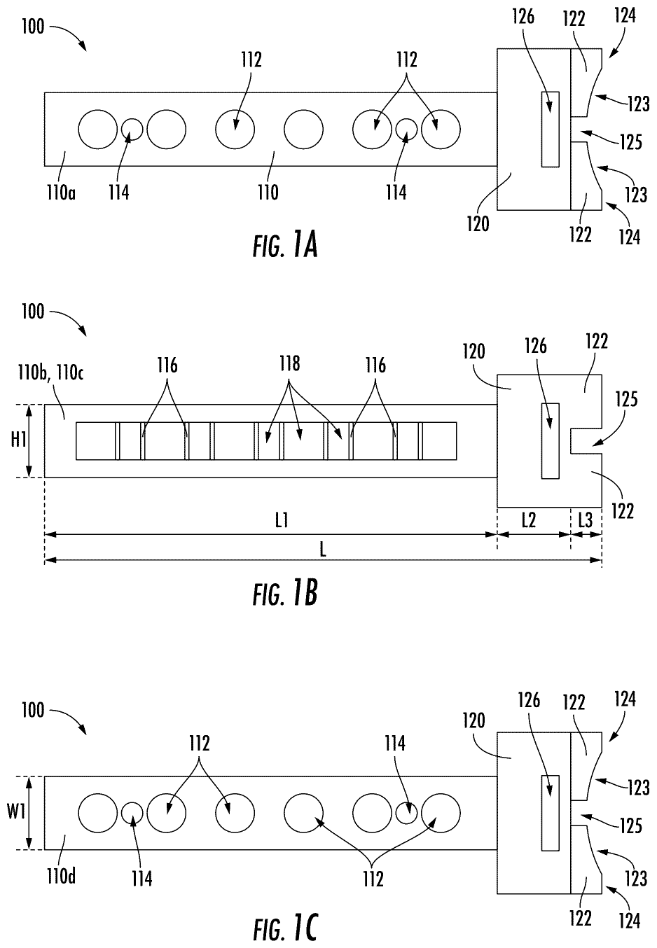

Pursuant to embodiments of the present invention, cable hanger mounts are provided. According to embodiments of the present invention, the cable hanger mounts are configured to help optimize cable management in constrained spaces at antenna installation sites, for example, at the top of an antenna tower. Embodiments of the present invention will now be discussed in greater detail with reference to FIGS. 1A-5B.

Referring to FIGS. 1A-1C, a cable hanger mount 100 according to embodiments of the present invention is illustrated. The cable hanger mount 100 may be referred to herein as a cable hanger standoff mount. As shown in FIGS. 1A-1C, in some embodiments, the cable hanger mount 100 includes a body section 110 and a base section 120. In some embodiments, the body section 110 of cable hanger mount 100 may have an elongated rectangular shape. In some embodiments, the body section 110 has a length (L1) in a range of between about 10 inches and about 14 inches, and typically has a length (L1) of about 12 inches. In some embodiments, the body section 110 has a height (H1) in a range of between about 0.5 inches and about 2 inches, and typically has a height (H1) of about 1 inch. In some embodiments, the body section 110 has a width (W1) in a range of between about 1 inch and about 3 inches, and typically has a width (W1) of about 2 inches. The body section 110 may be coupled to or integrally formed with the base section 120 and extends outwardly and generally perpendicularly therefrom. In some embodiments, the base section 120 has a length (L2) in a range of between about 1 inch and about 3 inches, and typically has a length (L2) of about 2 inches.

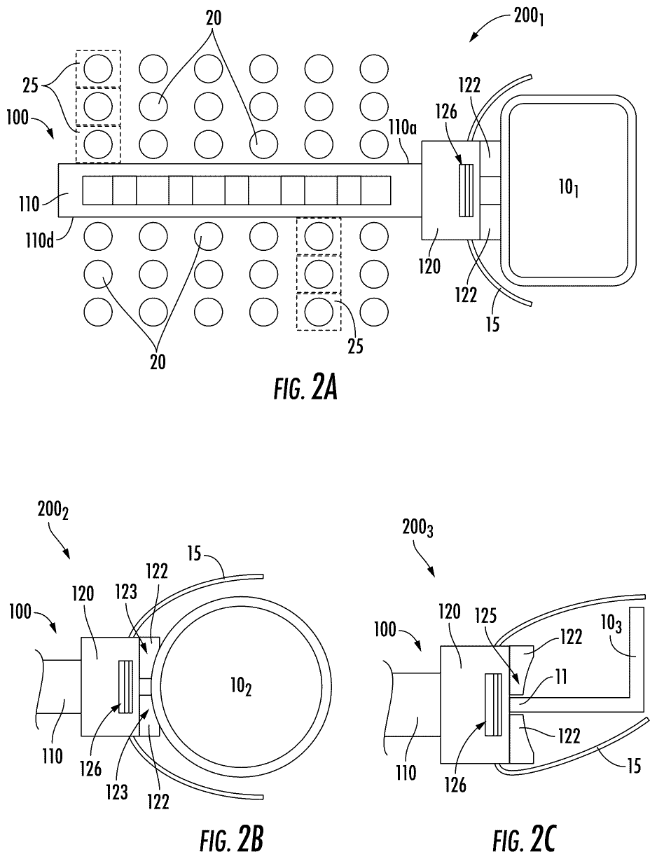

As described in further detail below, the body section 110 is configured to have a plurality of cable hangers 25 and/or associated cable hardware secured thereto (see, e.g., FIG. 2A) and the base section 120 is configured to engage with a mounting structure 10₁, 10₂, 10₃ to secure the mount 100 thereto (see, e.g., FIGS. 2A-2C). Together, the body section 110 and the base section 120 define an overall length (L) of the cable hanger mount 100. In some embodiments, the overall length (L) of the mount 100 may be about 15 inches. In other words, the cable hanger mount 100 is configured to extend a distance of about 15 inches from (i.e., “standoff from”) the corresponding mounting structure 10₁, 10₂, 10₃.

As further shown in FIG. 1A, in some embodiments, an upper wall 110a of the body section 110 comprises a plurality of apertures 112, 114. As shown in FIG. 1C, in some embodiments, a lower wall 310d of the body section 110 may also comprise a plurality of apertures 112, 114. Each aperture 112, 114 is configured to receive a respective cable hanger 25 or other cable hardware to secure the cable hanger 25 (or cable hardware) to the mount 100. In some embodiments, the apertures 112, 114 have different diameters. In some embodiments, one or more of the apertures 114 may have a smaller diameter than one or more of the apertures 112. For example, in some embodiments, one or more of the apertures 112 may have a diameter of about ¾ inch (e.g., suitable to receive a standard cable hanger 25), while one or more of the apertures 114 may have a diameter of about ⅜ inch (e.g., suitable for associated hardware). Example hardware includes, but is not limited to, a ⅜ inch bolt hardware kit available from CommScope Holding Company, Inc. (Product No. 243095 Series Hardware).

As shown in FIG. 1B, in some embodiments, opposing side walls 110b, 110c of the body section 110 may comprise a plurality of openings 118. In some embodiments, each opening 118 may be separated by an internal support member or wall 116. The openings 118 may be configured to provide space for an installer to easily access the cable hangers 25 secured directly to the mount 100, while the support members 116 may provide additional structural support to the body section 110, for example, when multiple cable hangers 25 (and corresponding cables 20) are secured thereto.

As shown in FIGS. 1A-1C, in some embodiments, the base section 120 may include at least one banding slot 126. The banding slot 126 is configured to receive a cable tie, zip tie, or other like banding mechanism 15 in order to attach and secure the cable hanger mount 100 to a respective mounting structure 10₁, 10₂, 10₃ (see, e.g., FIGS. 2A-2C). In some embodiments, the base section 120 may include a pair of engagement features 122. The engagement features 122 may extend outwardly from the base section 120 opposite to the body section 110. In some embodiments, the engagement features 122 may be configured to provide additional contact surface area for the cable hanger mount 100 to engage with certain types of mounting structure 10 (e.g., rectangular 10₁ or cylindrical/round 10₂). For example, in some embodiments, each engagement feature 122 may comprise a recessed (or concave) section 123 that is configured to receive at least a portion of an outer diameter of a cylindrical/round mounting structure 10₂ (e.g., a mounting pole) (see, e.g., FIG. 2B). In some embodiments, each engagement feature 122 may further comprise a planar (or flat) section 124 that is configured to contact a rectangular mounting structure 10₁ (e.g., a horizontal beam) (see, e.g., FIG. 2A).

As further shown in FIGS. 1A-1C, in some embodiments, the pair of engagement features 122 may be separated by a gap or notch 125. In some embodiments, the gap or notch 125 is configured to receive at least a portion of an angled mounting structure 10₃ (e.g., an angled steel beam) (see, e.g., FIG. 2C). In some embodiments, the notch 125 has a length (L3) in a range of between about 0.5 inches and about 2 inches, and typically has a length (L3) of about 1 inch.

Referring to FIGS. 2A-2C, example mounting assemblies according to embodiments of the present invention are illustrated. Each of the mounting assemblies 200₁, 200₂, 200₃ utilize the cable hanger mount 100 described herein and illustrate the capability of the mount 100 to be secured to a number of different mounting structure 10₁, 10₂, 10₃. As shown in FIG. 2A, a first mounting assembly 200₁ includes the mount 100 secured to a rectangular mounting structure 10₁, for example, a horizontal beam. The mount 100 is secured to the mounting structure 10₁ with a cable tie or band 15 routed through the banding slot 126 in the base section 120 (and around the mounting structure 10₁). In some embodiments, the engagement features 122 extending from the base section 120 provide a flush contact surface with the outer surface of the mounting structure 10₁. As further shown in FIG. 2A, a plurality of cable hangers 25 (and cables 20 retained therein) are secured above and below the body section 110 of the cable hanger mount 100 (i.e., extending outwardly from the upper and lower walls 110a, 110d of the body section 110). In some embodiments, the cable hanger mount 100 is configured to have up to three cable hangers 25 stacked together and secured to the mount 100 (i.e., per aperture 114 in the respective upper and lower walls 110a, 110d of the body section 110), thereby sufficiently organizing the corresponding cables 20 and optimizing cable management within the constrained space at the antenna installation site.

FIG. 2B illustrates a second mounting assembly 200₂ that includes the mount 100 secured to a cylindrical or round mounting structure 10₂, for example, a mounting pole. Similar to the mounting assembly 200₁ shown in FIG. 2A, the mount 100 is secured to the cylindrical or round mounting structure 10₂ with a cable tie or band 15 routed through the banding slot 126 in the base section 120 (and around the mounting structure 10₂). As shown in FIG. 2B, in some embodiments, the recessed (concave) sections 123 of the engagement features 122 are configured to receive a portion of the mounting structure 10₂ and provide a larger contact area between the mount 100 and the mounting structure 10₂.

FIG. 2C illustrates a third mounting assembly 200₃ that includes the mount 100 secured to an angled mounting structure 10₃, for example, an angled steel beam. Similar to the mounting assemblies 200₁, 200₂ shown in FIGS. 2A-2B, the mount 100 is secured to the angled mounting structure 10₃ with a cable tie or band 15 routed through the banding slot 126 in the base section 120 (and around the mounting structure 10₃). As shown in FIG. 2C, in some embodiments, the notch 125 between the engagement features 122 is configured to receive an end 11 of the angled mounting structure 10₃, as the cable tie or band 15 secures the mount 100 to the mounting structure 10₃.

While not shown in FIGS. 2B-2C, similar to the mounting assembly 200₁ shown in FIG. 2A, the cable hanger mount 100 in the mounting assemblies 200₂, 200₃ may be configured to have up to three cable hangers 25 stacked together and secured to the mount 100 (i.e., per aperture 114 in the body section 110), thereby sufficiently organizing the corresponding cables 20 for the corresponding mounting assemblies 200₂, 200₃ and optimizing cable management within the constrained space at the antenna installation site.

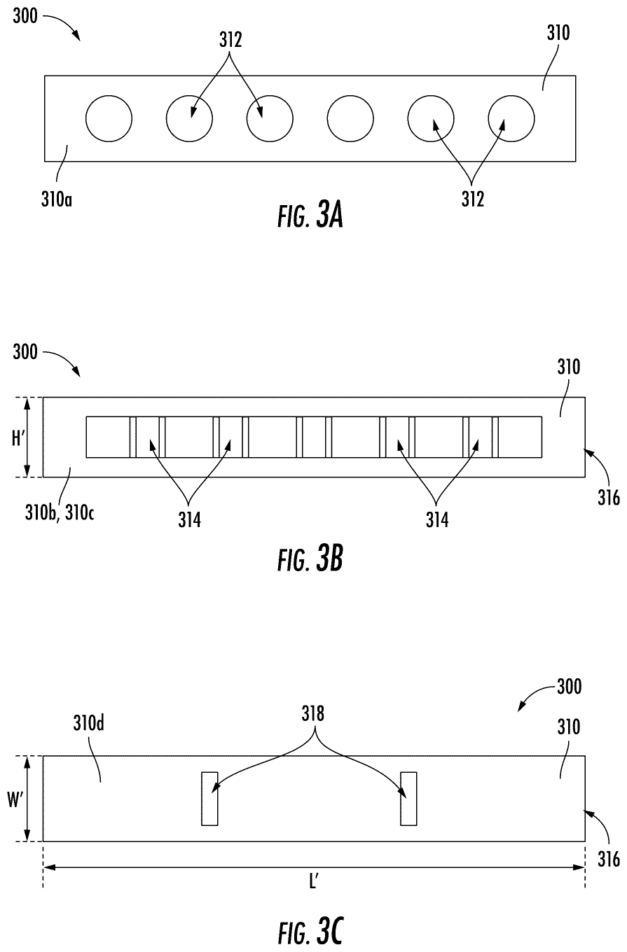

Referring to FIGS. 3A-3C, another cable hanger mount 300 according to embodiments of the present invention is illustrated. The cable hanger mount 300 may be referred to herein as a cable hanger beam mount. Properties and/or features of the cable hanger mount 300 may be as described above in reference to the cable hanger mount 100 shown in FIGS. 1A-1C, and duplicate discussion thereof may be omitted herein for the purposes of discussing FIGS. 3A-3C.

As shown in FIGS. 3A-3C, in some embodiments, the cable hanger mount 300 includes a body section 310. In some embodiments, the body section 310 of cable hanger mount 300 may have an elongated rectangular shape. In some embodiments, the body section 310 has a length (L′) in a range of between about 10 inches and about 14 inches, and typically has a length (L′) of about 12 inches. In some embodiments, the body section 310 has a height (H′) in a range of between about 0.5 inches and about 2 inches, and typically has a height (H′) of about 1 inch. In some embodiments, the body section 310 has a width (W′) in a range of between about 1 inch and about 3 inches, and typically has a width (W′) of about 2 inches.

As shown in FIG. 3A, in some embodiments, a front wall 310a of the body section 310 comprises a plurality of apertures 312. Each aperture 312 is configured to receive a respective cable hanger 25 to secure the cable hanger 25 to the mount 300. For example, in some embodiments, the apertures 312 may have a diameter of about ¾ inch (e.g., suitable to receive a standard cable hanger 25).

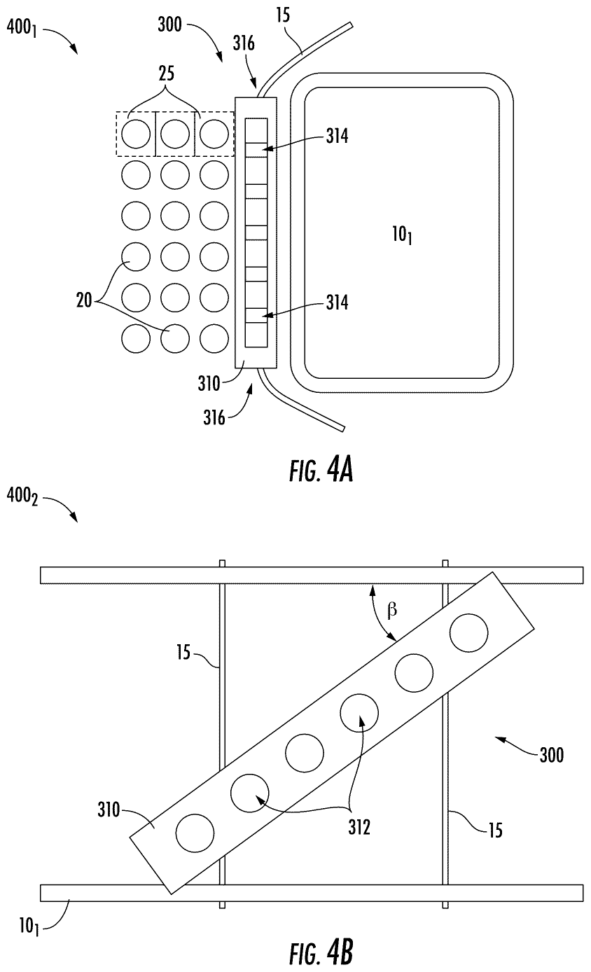

As shown in FIG. 3B, in some embodiments, opposing side walls 310b, 310c of the body section 310 may comprise a plurality of open slots 314. The open slots 314 are configured to provide space for a cable tie, zip tie, or other like banding mechanism 15 to be inserted through to secure the mount 100 to a mounting structure 10₁. In some embodiments, opposing ends of the body section 310 may comprise openings 316 that allow the cable tie, zip tie, or other like banding mechanism 15 to be routed through the ends of the body section 310 when securing the mount 100 to the mounting structure 10₁ (see, e.g., FIG. 4A).

As shown in FIG. 3C, in some embodiments, a rear wall 310d of the body section 310 may also include at least one banding slot 318. For example, in some embodiments, the rear wall 310d may include two banding slots 318. The banding slot(s) 318 are configured to receive a cable tie, zip tie, or other like banding mechanism 15 in order to attach and secure the cable hanger mount 100 to a respective mounting structure 10₁. In some embodiments, the banding slots 318 may be configured to allow the cable hanger mount 300 to be secured at an angle (β) relative to an edge of the mounting structure 10₁ (see, e.g., FIG. 4B), thereby providing additional space to access the cable hangers 25 secured thereto.

Referring to FIGS. 4A-4C, example mounting assemblies according to embodiments of the present invention are illustrated. Each of the mounting assemblies 400₁, 400₂ utilize the cable hanger mount 300 described herein and illustrate the capability of the mount 300 to be secured to a rectangular mounting structure 10₁ in different orientations. Properties and/or features of the mounting assemblies 400₁, 400₂ may be as described above in reference to the mounting assemblies 200₁, 200₂, 200₃ shown in FIGS. 2A-2C, and duplicate discussion thereof may be omitted herein for the purposes of discussing FIGS. 4A-4B.

A first mounting assembly 400₁ includes the mount 300 secured to a rectangular mounting structure 10₁, for example, a horizontal beam, is illustrated in FIG. 4A. As shown in FIG. 4A, the mount 300 is secured to the mounting structure 10₁ with a cable tie or band 15 routed through open slots 314 and end openings 316 of the body section 310 (and around the mounting structure 10₁). In some embodiments, the rear wall 310d of the body section 310 is configured to provide a flush contact surface with the outer surface of the mounting structure 10₁. As further shown in FIG. 4A, a plurality of cable hangers 25 (and cables 20 retained therein) are secured to the front wall 310a of the body section 310 of the cable hanger mount 300. In some embodiments, the cable hanger mount 300 is configured to have up to three cable hangers 25 stacked together and secured to the mount 300 (i.e., per aperture 312 in the body section 310, see also FIG. 3A), thereby sufficiently organizing the corresponding cables 20 and optimizing cable management within the constrained space at the antenna installation site.

FIG. 4B illustrates a second mounting assembly 400₂ that shows the capability of the mount 300 to be secured at a different orientation to the rectangular mounting structure 10₁. Similar to the mounting assembly 400₁ shown in FIG. 4A, the rear wall 310d of the mount 300 is configured to provide a flush contact surface with the outer surface of the mounting structure 10₁. The second mounting assembly 400₂ differs from the first mounting assembly 400₁ in that the mount 300 is secured to the mounting structure 10₁ with a cable tie or band 15 routed through the banding slots 318 in the rear wall 310d (and around the mounting structure 10₁). As shown in FIG. 4B, using the banding slots 318 in the rear wall 310 allows the mount 300 to be secured to the mounting structure 10₁ at an angle (β) relative to an edge of the mounting structure 10₁, thereby allowing for easier attachment of the cable hangers 25, for example, provides additional space to access and/or insert the cable hangers 25 into the respective apertures 312 in the mount 300.

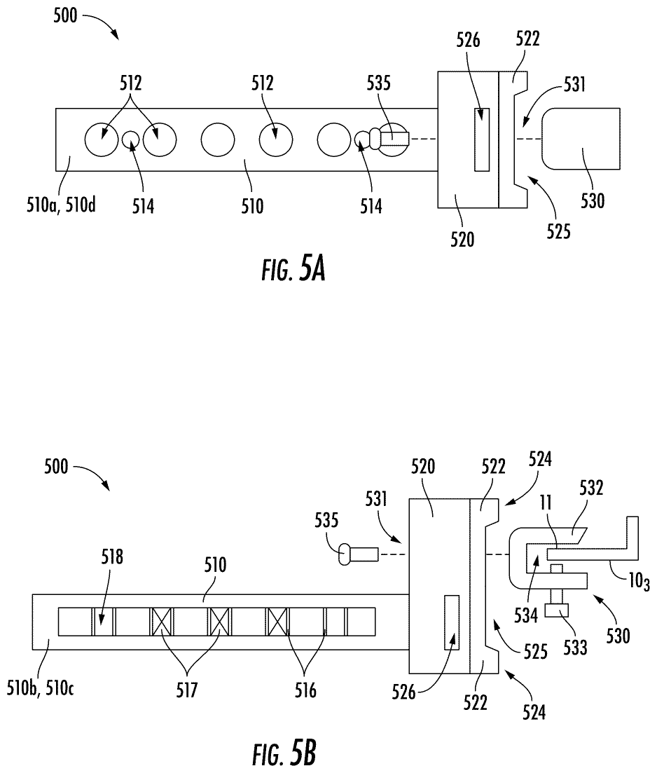

Referring to FIGS. 5A-5B, another cable hanger mount 500 according to embodiments of the present invention is illustrated. The cable hanger mount 500 may be referred to herein as a cable hanger standoff mount. Properties and/or features of the cable hanger mount 500 may be as described above in reference to the cable hanger mount 100 shown in FIGS. 1A-1C and duplicate discussion thereof may be omitted herein for the purposes of discussing FIGS. 5A-5B. As described further below, the cable hanger mount 500 primarily differs from the cable hanger mount 100 in that instead of having a notch or gap 125 configured to receive an end 11 of an angled mounting structure 10₃ (e.g., an angled steel beam), the cable hanger mount 500 comprises an angle adapter 530 configured to secure the cable hanger mount 500 to an angled mounting structure 10₃ (see, e.g., FIG. 5B).

As shown in FIGS. 5A-5B, in some embodiments, the cable hanger mount 500 includes a body section 510 and a base section 520. In some embodiments, the body section 510 of cable hanger mount 500 may have an elongated rectangular shape. The body section 510 may be coupled to or integrally formed with the base section 520 and extends outwardly and generally perpendicularly therefrom. The body section 510 is configured to have a plurality of cable hangers 25 and/or associated cable hardware secured thereto (similar to as shown in FIG. 2A) and the base section 520 is configured to engage with a mounting structure 10₁, 10₂ to secure the mount 500 thereto (similar to as shown in FIGS. 2A-2B).

As further shown in FIG. 5A, in some embodiments, an upper wall 510a of the body section 510 comprises a plurality of apertures 512, 514. In some embodiments, a lower wall 510b of the body section 510 may also comprise a plurality of apertures 512, 514. Each aperture 512, 514 is configured to receive a respective cable hanger 25 or other cable hardware to secure the cable hanger 25 (or cable hardware) to the mount 500. In some embodiments, the apertures 512, 514 have different diameters. In some embodiments, one or more of the apertures 514 may have a smaller diameter than one or more of the apertures 512. For example, in some embodiments, one or more of the apertures 512 may have a diameter of about ¾ inch (e.g., suitable to receive a standard cable hanger 25), while one or more of the apertures 514 may have a diameter of about ⅜ inch (e.g., suitable for associated cable hardware).

As shown in FIG. 5B, in some embodiments, opposing side walls 510b, 510c of the body section 510 may comprise a plurality of openings 518. In some embodiments, each opening 518 may be separated by an internal support member or wall 516. The openings 518 may be configured to provide space for an installer to easily access the cable hangers 25 secured directly to the mount 500, while the support members 516 may provide additional structural support to the body section 510, for example, when multiple cable hangers 25 (and corresponding cables 20) are secured thereto. In some embodiments, the body section 510 may also comprise one or more cross-support members 517 to provide further structural support to the body section 510.

As shown in FIGS. 5A-5B, in some embodiments, the base section 520 may include at least one banding slot 526. The banding slot 526 is configured to receive a cable tie, zip tie, or other like banding mechanism 15 in order to attach and secure the cable hanger mount 500 to a respective mounting structure 10₁, 10₂, 10₃ (similar to as shown in FIGS. 2A-2C). In some embodiments, the base section 520 may include an engagement feature 522. The engagement feature 522 may extend outwardly from the base section 520 opposite to the body section 510. In some embodiments, the engagement feature 522 may be configured to provide additional contact surface area for the cable hanger mount 500 to engage with certain types of mounting structures 10. For example, as shown in FIGS. 5A-5B, in some embodiments, the engagement feature 522 may comprise a recessed (or concave) section 525 that is configured to receive at least a portion of an outer diameter of a cylindrical/round mounting structure 10₂ (e.g., a mounting pole). In some embodiments, the engagement feature 522 may further comprise opposing planar (or flat) sections 524 that are configured to contact a rectangular mounting structure 10₁ (e.g., a horizontal beam).

As noted above, and as further shown in FIGS. 5A-5B, in some embodiments, the cable hanger mount 500 may further comprise an angle adapter 530. The angle adapter 530 is configured to be secured to the base section 520 of the mount 500, for example, via a fastener 535 received through an aperture 531 in the base section 520. As shown in FIG. 5B, in some embodiments, the angle adapter 530 has a main body 532 that defines a recess 534. In some embodiments, the main body 532 may be generally U-shaped. The main body 532 and recess 534 are configured to receive an end 11 of an angled mounting structure 10₃ (e.g., an angled steel beam) (similar to the notch 125 of cable hanger mount 100). A fastener 533 may then be used to secure the end 11 of the angled mounting structure 10₃ within the angle adapter 530, thereby securing the cable hanger mount 500 to the mounting structure 10₃.

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

1. A cable hanger mount, the cable hanger mount comprising:
a base section comprising a slot, the base section configured to engage a mounting structure and be secured to the mounting structure via a banding mechanism received through the slot; and
a body section coupled to or integrally formed with the base section and extending outwardly and generally perpendicularly therefrom, the body section comprising a plurality of apertures, each aperture configured to receive a respective cable hanger or hardware to secure the cable hanger or hardware to the mount.

2. The cable hanger mount according to claim 1, wherein the base section further comprises one or more engagement features extending outwardly from the base section opposite to the body section, the one or more engagement feature configured to provide additional contact surface area for the cable hanger mount to engage with different types of mounting structures.

3. The cable hanger mount according to claim 2, wherein each engagement feature comprises a recessed section configured to receive at least a portion of an outer diameter of a cylindrical or round mounting.

4. The cable hanger mount according to claim 2, wherein each engagement feature comprises a planar section configured to contact a rectangular mounting structure.

5. The cable hanger mount according to claim 2, wherein the base section comprises two engagement features separated by a gap, the gap configured to receive at least a portion of an angled mounting structure.

6. The cable hanger mount according to claim 1, further comprising an angle adapter configured to be secured to the base section, the angle adapter having a main body that defines a recess configured to receive an end of an angled mounting structure to secure the cable hanger mount thereto.

7. The cable hanger mount according to claim 1, wherein the body section has an elongated rectangular shape.

8. The cable hanger mount according to claim 1, wherein the body section comprises an upper wall having one or more of the plurality of apertures residing therein.

9. The cable hanger mount according to claim 1, wherein the body section comprises a lower wall having one or more of the plurality of apertures residing therein.

10.-12. (canceled)

13. The cable hanger mount according to claim 1, wherein the body section comprises opposing side walls, each side wall comprising a plurality of openings, each opening configured to provide space to access a cable hanger secured to the mount.

14.-17. (canceled)

18. A cable hanger mount, the cable hanger mount comprising:
a base section comprising a slot, the base section configured to engage a mounting structure and be secured to the mounting structure via a banding mechanism received through the slot;
a body section coupled to or integrally formed with the base section and extending outwardly and generally perpendicularly therefrom, the body section comprising a plurality of apertures, each aperture configured to receive a respective cable hanger or hardware to secure the cable hanger or hardware to the mount;
one or more engagement features extending outwardly from the base section opposite to the body section, the one or more engagement feature configured to provide additional contact surface area for the cable hanger mount to engage with different types of mounting structures; and
a removable angle adapter configured to be secured to the base section, the angle adapter having a main body that defines a recess configured to receive an end of an angled mounting structure to secure the cable hanger mount thereto.

19. The cable hanger mount according to claim 18, wherein each engagement feature comprises a recessed section configured to receive at least a portion of an outer diameter of a cylindrical or round mounting.

20. The cable hanger mount according to claim 18, wherein each engagement feature comprises a planar section configured to contact a rectangular mounting structure.

21. The cable hanger mount according to claim 18, wherein the body section has an elongated rectangular shape.

22. The cable hanger mount according to claim 18, wherein the body section comprises an upper wall having one or more of the plurality of apertures residing therein.

23. The cable hanger mount according to claim 18, wherein the body section comprises a lower wall having one or more of the plurality of apertures residing therein.

24. The cable hanger mount according to claim 18, wherein the plurality of apertures comprise apertures having different diameters.

25.-26. (canceled)

27. The cable hanger mount according to claim 18, wherein the body section comprises opposing side walls, each side wall comprising a plurality of openings, each opening configured to provide space to access a cable hanger secured to the mount.

28.-29. (canceled)

30. A cable hanger mount, the cable hanger mount comprising:
a body section having a generally elongated rectangular shape, the body section comprising, a front wall, a rear wall, and opposing side walls,
wherein the front wall comprises a plurality of apertures, each aperture configured to receive a respective cable hanger to secure the cable hanger to the mount, and
wherein the rear wall comprises at least one banding slot and the opposing side walls comprise a plurality of open slots, the slots in the rear wall and the opposing side walls are configured to receive a banding mechanism, thereby allowing the cable hanger mount to be secured to a mounting structure in different orientations relative to the mounting structure.

31. The cable hanger mount according to claim 30, wherein the at least one banding slot are configured to allow the cable hanger mount to be secured at an angle relative to an edge of the mounting structure.

32.-33. (canceled)
